(19) United States
(12) Patent Application Publication
(10) Pub. No.: US 2019/0211608 A1
(43) Pub. Date: Jul. 11, 2019

(54) Insurance Door and its Handle

(71) Applicant: Fengyu Yu, Shanghai City (CN)

(72) Inventor: Fengyu Yu, Shanghai City (CN)

(21) Appl. No.: 16/003,605

(22) Filed: Jun. 8, 2018

(30) Foreign Application Priority Data
Jan. 9, 2018 (CN) 201820032123.7

(51) Int. Cl. E05G 1/026; E05B 1/00

(52) U.S. Cl. CPC E05G 1/026; E05B 1/0007

(57) ABSTRACT

The utility model discloses a safe door and a hand grip thereof, relating to the technical field of security equipment. The hand grip of the safe door comprises a handle and a rotating shaft connected with a transmission mechanism of a lock of the safe door. The handle and the rotating shaft are detachably connected. With this arrangement, when the safe is transported and carried, or when the user wants to replace the handle with a handle of another model, only the connection between the handle and the rotating shaft needs to be released. When the safe is used, the connection between the handle and the rotating shaft is restored. The problem of cumbersome replacement of the handle of the safe door is solved, and the space occupied by the safe and the probability that the handle is damaged are reduced in the process of transporting and carrying the safe.

### CROSS REFERENCE TO RELATED APPLICATION

This application claims the benefit of and takes priority of Chinese Patent Application No. 201820032123.7 filed on Jan. 9, 2018, the contents of which are herein incorporated by reference.

### TECHNICAL FIELD

The utility model relates to the technical field of security equipment, and more particularly to a safe door and a hand grip thereof.

### BACKGROUND

With the continuous improvement of safety awareness of people, safes are used increasingly. The safe is a special type of container. Functionally, the safe comprises a fire-proof safe and an anti-theft safe. In the era of the Internet, people have more and more channels to purchase safes. Many users choose to purchase safes online. In the process that a logistics company transports and carries the safe, accidental collision that damages the handle of the hand grip of the safe door often occurs, or some users want to replace the handle with a handle of another model. At this time, the handle needs to be replaced. Since the existing hand grips of the safe doors are integrated, the handles are connected to the transmission mechanism of the lock of the safe door through screws or bolts. When the handle of the hand grip is damaged or the user wants to replace the handle with a handle of another model, the hand grip needs to be replaced as a whole. The replacement process is cumbersome. When the safe is transported using a container, the hand grip of the safe door will occupy a certain space and increase the volume of the container.

Therefore, how to solve the problem of cumbersome replacement of the handle of the safe door and reduce the space occupied by the safe and the probability that the handle is damaged in the process of transporting and carrying the safe is an important technical problem to be solved by the skilled in the art.

### SUMMARY

The purpose of the utility model is to provide a hand grip of a safe door, which solves the problem of cumbersome replacement of the handle of the safe door and reduces the space occupied by the safe and the probability that the handle is damaged in the process of transporting and carrying the safe.

The utility model provides a hand grip of a safe door, comprising a handle and a rotating shaft connected with a transmission mechanism of a lock of the safe door, wherein the handle and the rotating shaft are detachably connected.

Preferably, one of the handle and the rotating shaft is provided with a columnar structure, and the other thereof is provided with a hole which is matched with the columnar structure and into which the columnar structure is insertable, and the hand grip further comprises a limiting structure for preventing relative rotation between the handle and the rotation shaft.

Preferably, the handle and the rotating shaft are connected by a buckle structure.

Preferably, the buckle structure comprises a snap-fitting member and a neck, the snap-fitting member is capable of being snap-fit in the neck; one of the snap-fitting member and the neck is provided on the handle and the other thereof is provided on the rotating shaft.

Preferably, the neck is provided on the columnar structure, and the snap-fitting member is provided on a side wall of the hole.

Preferably, a limiting hole is provided on a side wall of the hole, the snap-fitting member comprises a bead, an elastic member and a blocking member, the diameter of the port of one end of the limiting hole near the hole is smaller than the diameter of the bead, both the bead and the elastic member are placed in the limiting hole, one end of the elastic member is connected to the bead, and the blocking member limits the bead and the elastic member in the limiting hole; the bead is pressed into the side wall of the hole and the elastic member is elastically deformed when the columnar structure is inserted into the hole, and the elastic member is restored to the original shape and the bead is returned to the original position when the neck is aligned with the limiting hole, so that the bead is snap-fit in the neck.

Preferably, the neck is provided as a ring extending circumferentially along the columnar structure, and the wall of the neck is provided as an arc capable of being matched with the sphere of the bead.

Preferably, the columnar structure is provided on the handle, the hole is provided along the axial direction of the rotating shaft, and the hole is provided at one end of the rotating shaft near the handle.

Preferably, the columnar structure is a hexagonal prism, the hole is a hexagonal prism-shaped hole, and the cylindrical surface of the hexagonal prism is matched with the inner wall surface of the hole to form the limiting structure.

The utility model also provides a safe door, which is provided with a hand grip. The hand grip is the hand grip according to any one of the above.

In the technical solution provided by the utility model, the hand grip of the safe door comprises a handle and a rotating shaft connected with a transmission mechanism of a lock of the safe door. The handle and the rotating shaft are detachably connected. When a logistics company transports and carries the safe, if accidental collision that damages the handle of the hand grip of the safe door occurs, or some users want to replace the handle with a handle of another model, the handle may be replaced only by releasing the connection between the handle and the rotating shaft. When a container is used for transportation, the connection between the handle and the rotating shaft may also be released, and the handle may be separately packaged and transported. This arrangement solves the problem of cumbersome replacement of the handle of the safe door, and may reduce the volume occupied by the safe and the probability that the handle is damaged in the process of transporting and carrying the safe.

### BRIEF DESCRIPTION OF THE DRAWINGS

In order to more clearly explain the embodiments of the utility model or the technical solutions in the prior art, the drawings to be used in the description of the embodiments or the prior art will be briefly described below. Obviously, the drawings in the following description are only some embodiments of the utility model. Those skilled in the art may also obtain other drawings based on these drawings without any creative work.

FIG. 1 is an exploded view of a safe door according to an embodiment of the utility model;

FIG. 2 is a structural view of a hand grip of a safe door according to an embodiment of the utility model;

FIG. 3 is an exploded view of a hand grip of a safe door according to an embodiment of the utility model;

FIG. 4 is a front view of a hand grip of a safe door according to an embodiment of the utility model;

FIG. 5 is a sectional view of A-A of FIG. 4;

FIG. 6 is a structural view of a rotating shaft according to an embodiment of the utility model;

FIG. 7 is a structural view of a safe door according to an embodiment of the utility model; and

FIG. 8 is a sectional view of A-A of FIG. 7.

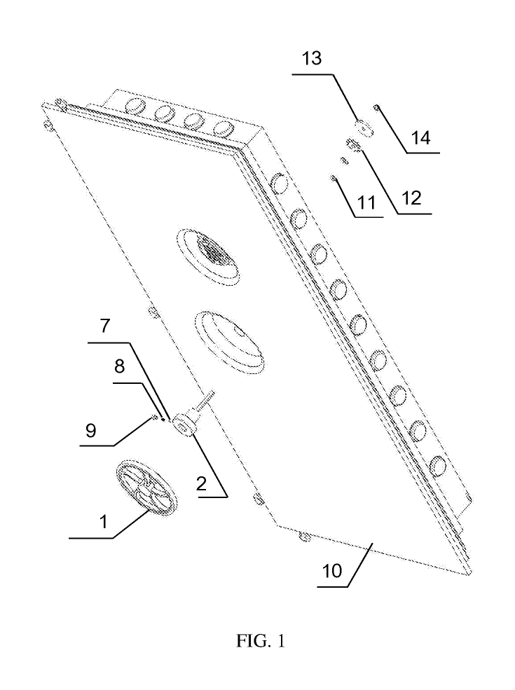

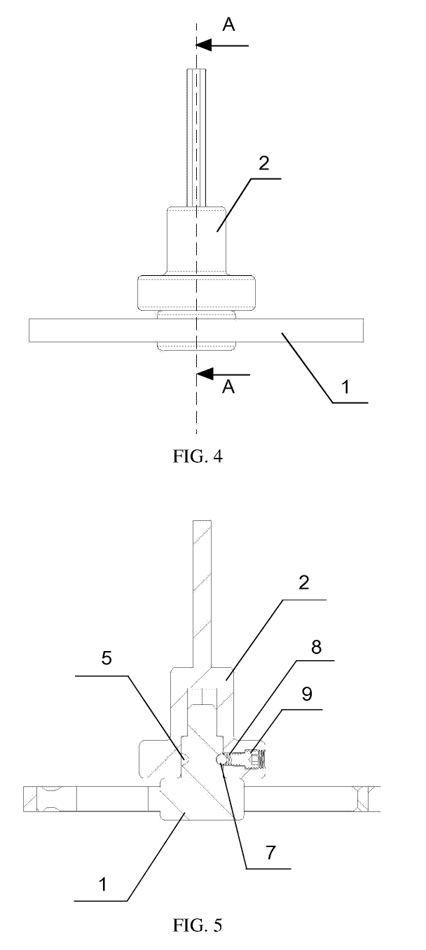

In FIGS. 1-8:

1-a handle, 2-a rotating shaft, 3-a columnar structure, 4-a hole, 5-a neck, 6-a limiting hole, 7-a bead, 8-an elastic member, 9-a bolt, 10-a door plate, 11-a first gasket, 12-a gear, 13-a second gasket, 14-a nut.

### DESCRIPTION OF THE EMBODIMENTS

To make the objectives, technical solutions, and advantages of the utility model clearer, the technical solutions of the utility model will be described in detail below. Obviously, the described embodiments are only a part of the embodiments of the utility model, rather than all of the embodiments. All other embodiments obtained by those skilled in the art based on the embodiments of the utility model without any creative work shall fall within the protection scope of the utility model.

The purpose of this embodiment is to provide a hand grip of a safe door, which solves the problem of cumbersome replacement of the handle of the safe door and reduces the space occupied by the safe and the probability that the handle is damaged in the process of transporting and carrying the safe.

Hereinafter, the embodiments will be described with reference to the drawings. In addition, the embodiments shown below do not impose any limitation on the content of the utility model described in the claims. In addition, the whole content of the structure shown by the following embodiment is not limited to what is necessary as a solution of the utility model described in the claims.

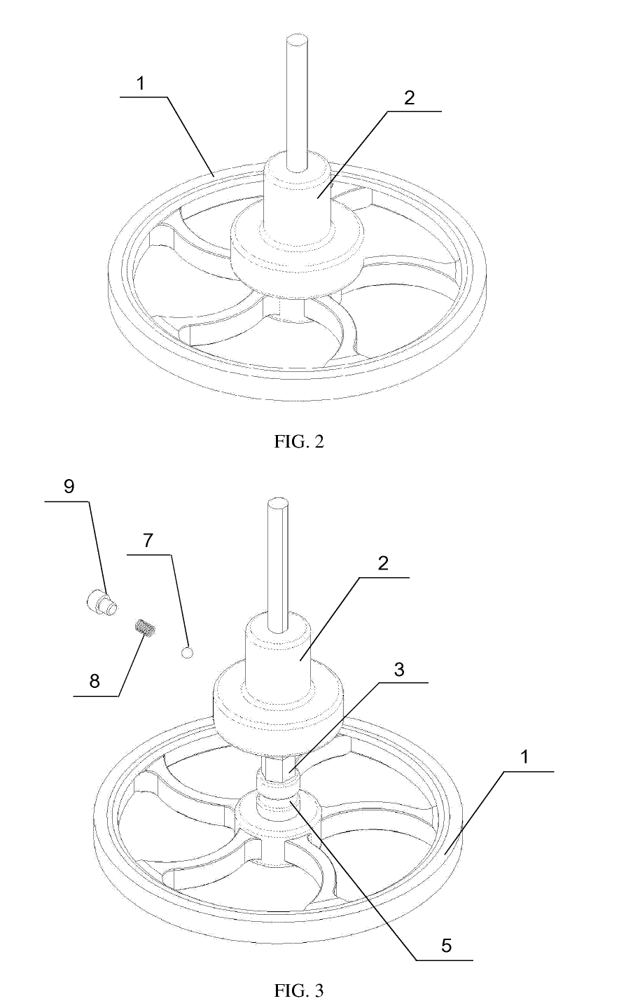

Referring to FIG. 2 to FIG. 5, this embodiment provides a hand grip of a safe door. The hand grip comprises a handle 1 and a rotating shaft 2. The rotating shaft 2 is connected with a transmission mechanism of a lock of the safe door. The safe door is opened in such way that the rotation of the rotating shaft 2 drives the transmission mechanism of the lock to move. The handle 1 is connected with the rotating shaft 2, and the handle 1 may be detached from the rotating shaft 2. When a logistics company transports and carries the safe, if accidental collision that damages the handle 1 of the hand grip of the safe door occurs, or some users want to replace the handle with a handle 1 of another model, the handle 1 is detached from the rotating shaft 2 only by releasing the connection between the handle 1 and the rotating shaft 2. When a container is used for transportation, the connection between the handle 1 and the rotating shaft 2 may also be released, and the handle 1 may be separately packaged and transported. When the handle 1 is installed, only the handle 1 and the rotating shaft 2 need to be connected, and then the rotating shaft 2 is rotated to open the safe door.

This arrangement solves the problem of cumbersome replacement of the handle 1 of the safe door, and may reduce the volume occupied by the safe and the probability that the handle 1 is damaged in the process of transporting and carrying the safe.

Referring to FIG. 3 and FIG. 6, in this embodiment, the handle 1 is provided with a columnar structure 3, and the rotating shaft 2 is provided with a hole 4. The hole 4 is provided at one end of the rotating shaft 2 near the handle 1, and the hole 4 is provided along the axial direction of the rotating shaft 2. The handle 1 and the rotating shaft 2 are connected through the columnar structure 3 and the hole 4. The size of the hole 4 is matched with the size of the columnar structure 3, and the shape of the hole 4 corresponds to the shape of the columnar structure 3. The columnar structure 3 may be inserted into the hole 4. The hand grip further comprises a limiting structure. When the columnar structure 3 is inserted into the hole 4, the limiting structure is used to prevent relative rotation between the handle 1 and the rotation shaft 2. When a user uses the safe, the handle 1 is rotated, and the handle 1 drives the rotation shaft 2 to rotate. The rotation shaft 2 is connected with the transmission mechanism at the inner side of the door plate 10 of the safe door. The rotation of the rotation shaft 2 drives the transmission mechanism to move so as to open the safe door. When a container is used for transporting and carrying the safe, the columnar structure 3 on the handle 1 is pulled out of the hole 4 in the rotating shaft 2 and the handle 1 is separately packaged and transported; after the safe is put in place, the columnar structure 3 of the handle 1 is inserted into the hole 4 of the rotation shaft 2, and the relative position between the handle 1 and the rotation shaft 2 is then limited by the limiting structure so as to prevent relative rotation between the handle 1 and the rotation shaft 2 when the handle 1 is rotated.

It should be noted that in other embodiments, the positions of the columnar structure 3 and the rotating shaft 2 may be interchanged. That is, the columnar structure 3 may be provided on the handle 1, the hole 4 may be provided on the rotating shaft 2, the columnar structure 3 may also be provided on the rotating shaft 2, and the hole 4 may be provided on the handle 1. “Axial direction” is usually the direction of the rotating central shaft of a cylinder for a cylindrical object, which is the direction common to the central shaft. In this embodiment, “axial direction” specifically refers to the direction of the center shaft of the rotating shaft 2.

With this arrangement, the handle 1 is connected with the rotating shaft 2 in such a way that the cylindrical structure 3 is insert into the hole 4 and then the restriction structure prevents the columnar structure 3 from rotating relative to the hole 4. The columnar structure 3 is pulled out of the hole 4 to separate the handle 1 from the rotating shaft 2. When transporting or the user wants to replace the model of the handle 1, the problem of cumbersome disassembly and assembly of the handle 1 is solved, and the handle 1 is disassembled and then assembled into the container, which may reduce the volume occupied by the safe and reduce the probability that the handle 1 is damaged at the same time.

In a preferred embodiment of this embodiment, the shape of the handle 1 is set to be circular. With this arrangement, it is convenient for the user to rotate the handle 1 when opening the safe door, and the user may perform the operation of opening the safe door by holding any portion of the circle of the handle 1. Of course, in other embodiments, the shape of the handle 1 may also be set as a polygon, a straight shape, or the like.

In this embodiment, the handle 1 and the rotating shaft 2 are connected by a buckle structure. The buckle structure comprises a snap-fitting member and a neck 5, the snap-fitting member is capable of being snap-fit in the neck 5; the neck 5 is provided on the handle 1 and the snap-fitting member is provided on the rotating shaft 2. In some embodiments, the snap-fitting member may be provided as a hanging loop, and the neck 5 may be provided as a hanging position where the hanging loop is hung. When the columnar structure 3 is inserted into the hole 4, the hanging loop is hung on the hanging position to prevent the handle 1 and the rotating shaft 2 from being separated in use. Of course, the buckle structure may also be provided with other structures. After the columnar structure 3 is inserted into the hole 4, this structure can prevent the snap-fitting member and the neck 5 from being separated when the hand grip is in use.

It should be noted that, in other embodiments, the installation positions of the neck 5 and the snap-fitting member may be interchanged. That is, the neck 5 may be provided on the handle 1, and the snap-fitting member is provided on the rotating shaft 2. The neck 5 may also be provided on the rotating shaft 2, and the snap-fitting member is provided on the handle 1.

With this arrangement, when the safe is in use, the columnar structure 3 on the handle 1 is inserted into the hole 4 on the rotating shaft 2. The position between the handle 1 and the rotating shaft 2 is limited by the limiting structure so as to prevent the relative rotation between the handle 1 and the rotation shaft 2 when the handle 1 is rotated. Then, the handle 1 and the rotating shaft 2 are connected through the buckle structure to prevent the handle 1 and the rotating shaft 2 from being separated when in use. Since the rotating shaft 2 is connected with the transmission mechanism of the lock of the safe door, the rotation of the handle 1 drives the rotation shaft 2 to rotate so that the rotating shaft 2 drives the transmission mechanism of the lock to move so as to open the safe door.

Referring to FIG. 3, FIG. 5 and FIG. 6, in this embodiment, the neck 5 is provided on the columnar structure 3, and the snap-fitting member is provided on a side wall of the hole 4. The snap-fitting member comprises a bead 7, an elastic member 8 and a blocking member. A limiting hole 6 is provided on a side wall of the hole 4. The limiting hole 6 is a through-hole. The diameter of the port of one end of the limiting hole 6 near the hole 4 is smaller than the diameter of the bead 7. Both the bead 7 and the elastic member 8 are placed in the limiting hole 6, one end of the elastic member 8 is connected to the bead 7, and the blocking member limits the bead 7 and the elastic member 8 in the limiting hole 6. At this time, a part of the bead 7 is located in the hole 4, but the bead 7 cannot enter the hole 4 through the limiting hole 6. The bead 7 is pressed by the columnar structure 3 and returns to the side wall of the hole 4 and the elastic member 8 is elastically deformed when the columnar structure 3 is inserted into the hole 4. The elastic member 8 is restored to the original shape and the bead 7 is returned to the original position when the neck 5 provided on the columnar structure 3 is aligned with the port of the limiting hole 6 in the process that the columnar structure 3 is continuously inserted, so that the bead 7 is snap-fit in the neck 5. The relative rotation between the handle 1 and the rotating shaft 2 is prevented by the limiting structure. At this time, the rotation of the handle 1 may drive the transmission mechanism of the lock of the safe door to move, thereby opening the safe door.

It should be noted that in a preferred embodiment of this embodiment, the bead 7 is provided as a steel ball, and the elastic member 8 is provided as a spiral spring. Of course, in other embodiments, the bead 7 may also be a resin bead, such as a fluorine plastic bead, etc. The elastic member 8 may also be a plate spring, etc. In this embodiment, the blocking member is a bolt 9, the bolt 9 is provided with an external thread, the limiting hole 6 is provided with an internal thread, and the external thread of the bolt 9 and the internal thread of the limiting hole 6 may cooperate with each other. The bead 7 and the elastic member 8 are limited within the limiting hole 6 by the bolt 9. In other embodiments, the blocking member may also be a pin, etc.

With this arrangement, the assembly and disassembly between the handle 1 and the rotating shaft 2 may be achieved in a plug-push manner, which is convenient in operation. Moreover, the handle 1 may not be easily detached from the rotating shaft 2 due to the action of the buckle structure in use.

In this embodiment, the neck 5 is provided on the columnar structure 3. The neck 5 extends circumferentially along the columnar structure 3 and is wound on the columnar structure 3 in a ring manner. The wall of the neck 5 is provided as an arc matched with the sphere of the bead 7. After the columnar structure 3 is inserted into the hole 4, the bead 7 is just snap-fit in the neck 5. With this arrangement, when the hand grip is in use, the bead 7 is snap-fit in the neck 5, and the handle 1 will not be detached from the rotating shaft 2. When some users want to replace or disassemble the handle 1, the handle 1 may be detached from the rotating shaft 2 only by pulling the handle 1 along the axial direction of the rotating shaft 2 with force. This arrangement solves the problem of cumbersome disassembly and assembly of the handle 1, and may both save the space of the container and reduce the probability that the handle 1 is damaged by disassembling the handle 1 from the safe door in the process of transporting and carrying the safe.

Referring to FIG. 3 and FIG. 6, in this embodiment, the columnar structure 3 is provided as a hexagonal prism, the corresponding hole 4 in which the hexagonal prism is inserted is a hexagonal prism-shaped hole 4. The columnar structure 3 is inserted into the hole 4. The cylindrical surface of the hexagonal prism is matched with the inner wall surface of the hole 4 to form a limit structure between the handle 1 and the rotating shaft 2. With this arrangement, when the hand grip is in use, the rotation of the handle 1 may drive the transmission mechanism of the lock of the safe door to move to prevent the relative rotation between the handle 1 and the rotating shaft 2 when the handle 1 is rotated, and the safe door cannot be opened.

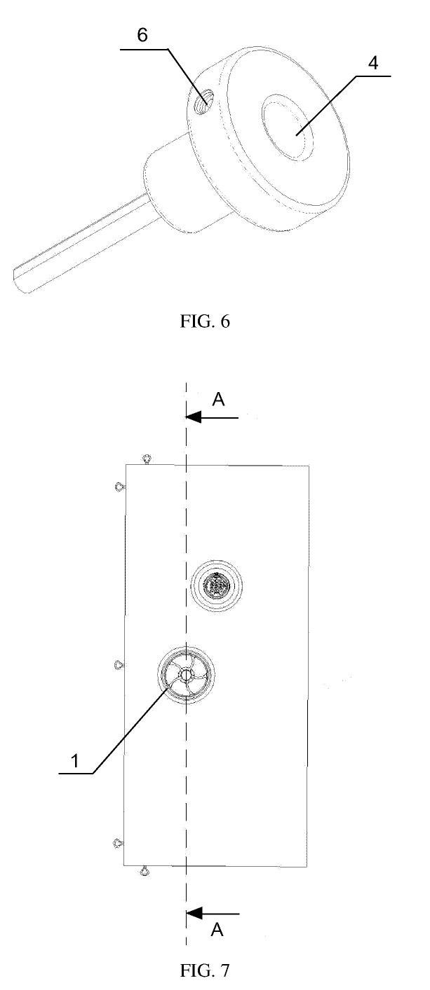

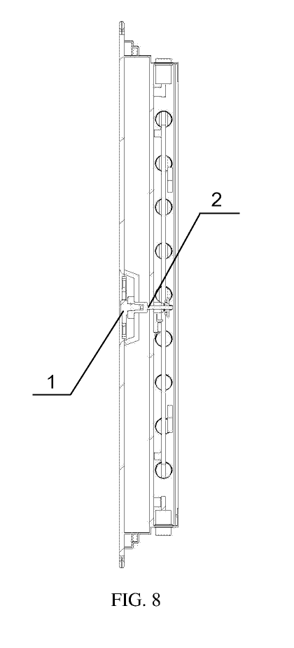

As shown in FIG. 7 and FIG. 8, in a preferred embodiment of this embodiment, the position where the hand grip is installed on the door plate 10 of the safe is provided as a recessed shape. When the handle 1 is installed on the rotating shaft 2, the handle 1 is just located in the recess of the door plate 10. With this arrangement, when the safe is transported, the volume of the container may also be reduced, and at the same time, the probability that the handle 1 is damaged is reduced.

The hand grip of the safe door will be described in detail with reference to each of the above embodiments below. Referring to FIG. 1 to FIG. 8, the hand grip of the safe door comprises a handle 1 and a rotating shaft 2, and the handle 1 and the rotating shaft 2 are detachably connected. The rotating shaft 2 is connected with the transmission mechanism of the lock of the safe door. The door plate 10 of the safe door is provided with a through-hole into which the rotating shaft 2 is inserted. After the rotating shaft 2 is inserted into the through-hole, two first gaskets 11, a gear 12 and a second gasket 13 are sequentially installed on the part of the rotating shaft 2 at the inner side of the door plate 10. The first gaskets 11, the gear 12 and the second gasket 13 described above are then fixed to the rotating shaft 2 through the nut 14. The gear 12 is a part of the transmission mechanism of the lock. The rotation of the rotating shaft 2 drives the transmission mechanism of the lock to move to open the safe door. The handle 1 is a round handle 1. There is a recess in the position where the hand grip is installed on the safe door. After the hand grip is installed on the safe door, the handle 1 is just located in the recess of the safe door.

The handle 1 is provided with a hexagonal prism-shaped columnar structure 3. The columnar structure 3 is provided with a neck 5 extending along a circumferential direction of the columnar structure 3. The wall of the neck 5 is provided as an arc matched with the sphere of the bead 7. One end of the rotating shaft 2 near the handle 1 is provided with a hole 4. The hole 4 is provided along the axial direction of the columnar structure 3. The hole 4 is provided in a hexagonal prism shape, into which the columnar structure 3 is insertable. The cylindrical surface of the hexagonal prism is matched with the inner wall surface of the hole 4 to prevent relative rotation between the handle 1 and the rotating shaft 2. A limiting hole 6 is provided on the side wall of the hole 4. A bead 7 and an elastic member 8 are provided within the limiting hole 6. The diameter of the limiting hole 6 is smaller than the diameter of the bead 7. One end of the elastic member 8 is connected to the bead 7. The limiting hole 6 is provided with an internal thread, and the limiting hole 6 is then sealed by an externally threaded bolt 9 matched with the limiting hole 6 to prevent the bead 7 and the elastic member 8 from slipping out of the limiting hole 6.

The bead 7 is pressed by the columnar structure 3, the bead 7 returns to the side wall of the hole 4, and the elastic member 8 is elastically deformed when the columnar structure 3 is inserted into the hole 4. The columnar structure 3 continues to be inserted into the hole 4. The elastic member 8 is restored to the original shape and the bead 7 is returned to the original position when the neck 5 is aligned with the limiting hole 6. At this time, the bead 7 is snap-fit in the groove 5, and the handle 1 and the rotation shaft 2 are connected together. Pulling the handle 1 along the axial direction of the rotating shaft 2 with force may disconnect the handle 1 from the rotating shaft 2.

With this arrangement, the columnar structure 3 is inserted into the hole 4, and the bead 7 is snap-fit in the neck 5. The handle 1 and the rotating shaft 2 are connected together. At this time, the handle 1 is rotated to open the safe door; when a container is used for transportation or the user wants to replace the hand grip, the handle 1 is disconnected from the rotating shaft 2 by pulling the handle 1 along the axial direction of the rotating shaft 2 with force. At this time, the handle 1 may be separately packaged and transported, or may be replaced with the handle 1 of another model.

This embodiment further provides a safe door provided with a hand grip, which is the handle described in the above embodiment. With this arrangement, the safe door provided in this embodiment may be used to disassemble, separately package and transport the handle 1 of the hand grip of the safe door when the safe is transported. When the user wants to replace the handle 1, the handle 1 may be disassembled to replace with the handle 1 of another model; when the handle 1 is installed, the hexagonal prism-shaped columnar structure 3 is inserted into the hole 4, and the bead 7 is snap-fit in the groove 5, so that the handle 1 may be rotated to open the safe door. The derivation process of the beneficial effect is substantially similar to the derivation process of the beneficial effect brought by the hand grip of the safe door described above, which will not be described herein.

The foregoing descriptions are merely specific embodiments of the utility model, but the protection scope of the utility model is not limited thereto. Any changes or replacements conceivable by those skilled in the art within the technical scope disclosed by the utility model should fall within the protection scope of the utility model. Therefore, the protection scope of the utility model shall be subject to the protection scope of the claims.

What is claimed is:

1. A hand grip of a safe door, comprising: a handle (1) and a rotating shaft (2) connected with a transmission mechanism of a lock of the safe door, wherein the handle (1) and the rotating shaft (2) are detachably connected.

2. The hand grip according to claim 1, wherein one of the handle (1) and the rotating shaft (2) is provided with a columnar structure (3), and the other thereof is provided with a hole (4) which is matched with the columnar structure (3) and into which the columnar structure (3) is insertable, and the hand grip further comprises a limiting structure for preventing relative rotation between the handle (1) and the rotation shaft (2).

3. The hand grip according to claim 2, wherein the handle (1) and the rotating shaft (2) are connected by a buckle structure.

4. The hand grip according to claim 3, wherein the buckle structure comprises a snap-fitting member and a neck (5), the snap-fitting member is capable of being snap-fit in the neck (5); one of the snap-fitting member and the neck (5) is provided on the handle (1) and the other thereof is provided on the rotating shaft (2).

5. The hand grip according to claim 4, wherein the neck (5) is provided on the columnar structure (3), and the snap-fitting member is provided on a side wall of the hole (4).

6. The hand grip according to claim 5, wherein a limiting hole (6) is provided on a side wall of the hole (4), the snap-fitting member comprises a bead (7), an elastic member (8) and a blocking member, the diameter of the port of one end of the limiting hole (6) near the hole (4) is smaller than the diameter of the bead (7), both the bead (7) and the elastic member (8) are placed in the limiting hole (6), one end of the elastic member (8) is connected to the bead (7), and the blocking member limits the bead (7) and the elastic member (8) in the limiting hole (6); the bead (7) is pressed into the side wall of the hole (4) and the elastic member (8) is elastically deformed when the columnar structure (3) is inserted into the hole (4), and the elastic member (8) is restored to the original shape and the bead (7) is returned to the original position when the neck (5) is aligned with the limiting hole (6), so that the bead (7) is snap-fit in the neck (5).

7. The hand grip according to claim 6, wherein the neck (5) is provided as a ring extending circumferentially along the columnar structure (3), and the wall of the neck (5) is provided as an arc capable of being matched with the sphere of the bead (7).

8. The hand grip according to claim 2, wherein the columnar structure (3) is provided on the handle (1), the hole (4) is provided along the axial direction of the rotating shaft (2), and the hole (4) is provided at one end of the rotating shaft (2) near the handle (1).

9. The hand grip according to claim 2, wherein the columnar structure (3) is a hexagonal prism, the hole (4) is a hexagonal prism-shaped hole (4), and the cylindrical surface of the hexagonal prism is matched with the inner wall surface of the hole (4) to form the limiting structure.

10. A safe door provided with a hand grip, wherein the hand grip is the hand grip according to claim 1.
